(19) United States
(12) Patent Application Publication
(10) Pub. No.: US 2004/0198464 A1
(43) Pub. Date: Oct. 7, 2004

(54) Wireless communication systems for vehicle-based private and conference calling and methods of operating same

(76) Inventor: Jim Panian, Cary, NC (US)

Correspondence Address: MYERS BIGEL SIBLEY & SAJOVEC, PO BOX 37428, RALEIGH, NC, 27627, US

(21) Appl. No.: 10/378,959

(22) Filed: Mar. 4, 2003

(51) Int. Cl. H04B 5/00

(52) U.S. Cl. 455/569.1; 455/41.1

(57) ABSTRACT

A wireless communication system for vehicle-based private and conference calling includes a wireless terminal that is configured to support bidirectional wireless audio communication with a vehicle-based user headset and a vehicle-based conference accessory. The wireless terminal operates as a switching node that is configured to support uninterrupted transfer of an already established first bidirectional wireless audio communication link from the headset to the conference accessory. This transfer may be made in response to a first command. The first bidirectional wireless audio communication link may be a spread spectrum, frequency hopping, full-duplex signal.

### FIELD OF THE INVENTION

The present invention relates to wireless communication devices and, more particularly, to wireless communication devices that support handsfree operation.

### BACKGROUND OF THE INVENTION

Many municipalities require handsfree operation of a wireless terminal (e.g., cellular telephone) in a vehicle. To meet these requirements, Bluetooth™ wireless technology has been implemented to provide a bidirectional wireless audio communication link between a handsfree accessory and a cellular phone. For example, as illustrated by FIG. 1, a driver of a vehicle may utilize a Bluetooth™ compatible headset 10 to conduct a private telephone call with a remote call recipient. This telephone call may initially be established as an incoming or outgoing call using a wireless terminal 20. Then, in response to a command or control signal, a bidirectional wireless audio communication link 30 may be established between the wireless terminal 20 and the headset 10. The control signal may be automatically generated within the wireless terminal 20 in response to preconfigured settings or the control signal may be generated in response to action by the driver. For example, the driver may initially access the wireless terminal through its keypad and display in order to set up the link 30 once the call has been established.

U.S. Pat. No. 6,405,027 to Bell also discloses the use of Bluetooth™ technology to establish a wireless group conference call. In particular, FIG. 1A of the '027 patent illustrates a Bluetooth™ enabled mobile cellular handset D₀ that operates as a “master” device in a piconet that includes a plurality of Bluetooth™ enabled “slave” devices D₂-Dₙ. As illustrated by FIG. 3 of the '027 patent, a group conference call may be achieved by initially establishing a call between the master device D₀ and a first call recipient D₁. This first call may require the use of a base station 12 located in proximity to the master device D₀. This first call recipient is then placed on hold while a series of additional group members are contacted individually and placed on hold until all members of a call group have been properly contacted. Once all members have been properly contacted, the “on-hold” condition associated with each member of the group is released and the group conference call is commenced.

### SUMMARY OF THE INVENTION

Wireless communication systems according to embodiments of the present invention can include a wireless terminal that is configured to support private and conference calling in a handsfree environment, such as a vehicle environment. Typical wireless terminals include cellular telephones and PCS and PDA handsets, for example. In some embodiments, a wireless communication system for vehicle-based private and conference calling includes a wireless terminal having both private and conference call capability. The wireless terminal is configured to support bidirectional wireless audio communication with a vehicle-based user headset and a vehicle-based conference accessory. This conference accessory may be a handsfree accessory that is permanently mounted or integrated within the vehicle. The wireless terminal operates as a switching node that is configured to support uninterrupted transfer of an already established first bidirectional wireless audio communication link from the headset to the conference accessory. This transfer operation may be made in response to a first command, such as a voice command from a driver of the vehicle. This first command may also be entered into the wireless terminal using conventional techniques (e.g., keypad entry using a menu-based display). The wireless terminal is further configured to support uninterrupted return of the first wireless audio communication link from the conference accessory to the headset. This return operation may be made in response to a second command, which may also be a voice command. In the event Bluetooth™ compatible technology is used, then the first bidirectional wireless audio communication link may be established as a spread spectrum (e.g., 2.4 GHZ spectrum), frequency hopping, full-duplex signal that hops at 1 MHz intervals.

In some other embodiments of the present invention, a wireless communication system for private and conference calling includes a wireless terminal that is configured to support bidirectional wireless audio communication with a handsfree accessory and a conference accessory. In this embodiment, the wireless terminal operates as a switching node that is configured to convert a first bidirectional wireless audio communication link, which extends between the wireless terminal and the handsfree accessory, into a second bidirectional wireless audio communication link, which extends between the wireless terminal and the conference accessory. This conversion operation may be performed in response to a first command. The wireless terminal is also configured to terminate the second bidirectional wireless audio communication link and reestablish the first bidirectional wireless audio communication link. These operations may be responsive to a second command.

Additional embodiments of the present invention include a wireless terminal that is configured to support wireless communication with first and second handsfree (or handheld) accessories. In this embodiment, the wireless terminal operates as a switching node that is configured to generate an outgoing first wireless communication link from the wireless terminal to the first accessory and simultaneously generate an alternative format version of the outgoing first wireless communication link from the wireless terminal to the second accessory. This alternative format version of the outgoing first wireless communication link may be a format that is compatible with devices that do not generate acoustic signals. For example, devices such as printers and displays or other devices that support communication with a hearing-impaired member of a conference call may be used.

Still further embodiments of the present invention include a wireless terminal that is configured to support bidirectional wireless audio communication with a plurality of vehicle-based audio accessories having different call priorities. The wireless terminal includes a communication control circuit that is configured to at least periodically monitor an active/inactive state of a first one of the plurality of audio accessories (e.g., headset) having a highest call priority. The control circuit is further configured to automatically switch an active bidirectional wireless audio communication link from the first one of the plurality of audio accessories to a second one of the plurality of audio accessories having a next highest call priority (e.g., conference accessory) upon detection that the first one of the plurality of audio accessories has become inactive. The control circuit is also configured to automatically switch the active bidirectional wireless audio communication link back from the second one of the plurality of audio accessories back to the first one of the plurality of audio accessories upon detection that the first one of the plurality of audio accessories has become active again. In this manner, it is not necessary to generate a voice command or manually access the wireless terminal in order to have the terminal switch back and forth from one audio accessory to another audio accessory. In these embodiments, the first one of the plurality of audio accessories may be a vehicle-based headset and the second one of the plurality of audio accessories may be a vehicle-based conference accessory. The communication control circuit may also include programmable storage elements that are configured to retain the call priorities and enable reordering of the high-to-low call priority hierarchy, if necessary.

Embodiments that use call priorities to facilitate audio link switching also include a wireless terminal having a communication control circuit therein that is configured to detect an active-to-inactive transition (i.e., on-to-off transition) of a first one of the plurality of accessories having a highest priority and is further configured to automatically switch an active wireless communication link from the first one of the plurality of accessories to a second one of the plurality of accessories having a next highest priority upon detection of the active-to-inactive transition. The control circuit is also configured to detect an inactive-to-active transition (i.e., off-to-on transition) of the first one of the plurality of accessories. When this transition is detected, the control circuit operates to automatically switch the active wireless communication link from the second one of the plurality of accessories back to the first one of the plurality of accessories.

Still further embodiments of the present invention include methods of conducting a private conversation with the remote call recipient using a vehicle-based headset that communicates with a wireless terminal using a bidirectional wireless audio communication link. An operation is then performed to switch from the private conversation to a public conference with the call recipient, by redirecting the bidirectional wireless audio communication link from the headset to a vehicle-based handsfree conference accessory, using the wireless terminal as a switching node. This redirecting operation is preferably performed without interruption of the call with the recipient. Next, an operation is performed to return to the private conversation by redirecting the bidirectional wireless audio communication link from the conference accessory to the headset, again without interruption.

### BRIEF DESCRIPTION OF THE DRAWINGS

FIG. 1 illustrates wireless communication between a headset and a wireless terminal, according to the prior art.

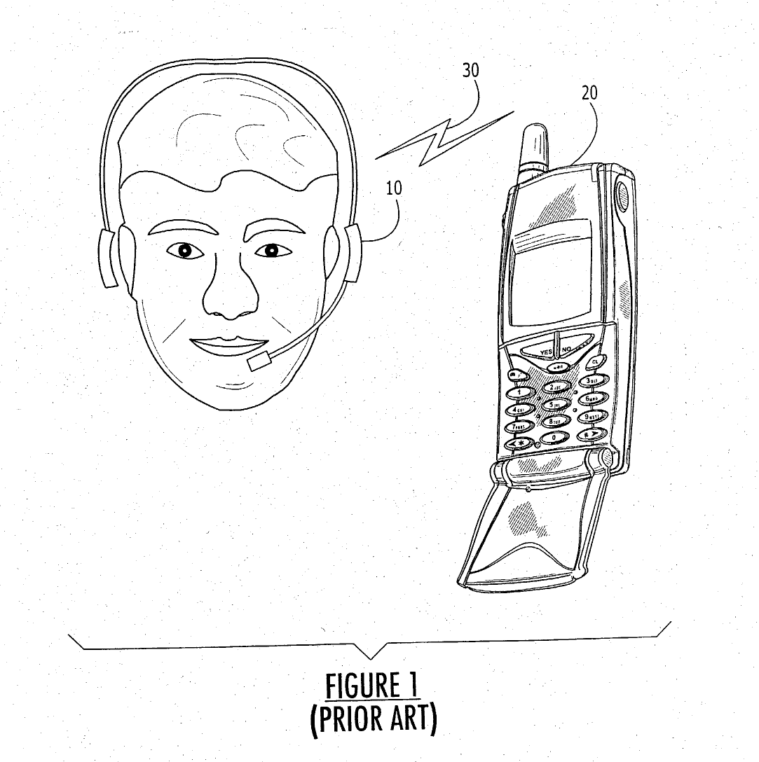

FIG. 2 illustrates wireless communication between a headset and a wireless terminal and between a handsfree accessory and the wireless terminal, according to an embodiment of the present invention.

FIG. 3 is a flow diagram of operations that illustrates methods of conducting a vehicle-based conference call with a remote call recipient according to embodiments of the present invention.

FIG. 4 is a block diagram of the wireless terminal of FIG. 2, according to an embodiment of the present invention.

### DESCRIPTION OF PREFERRED EMBODIMENTS

The present invention now will be described more fully herein with reference to the accompanying drawings, in which preferred embodiments of the invention are shown. This invention may, however, be embodied in many different forms and should not be construed as being limited to the embodiments set forth herein; rather, these embodiments are provided so that this disclosure will be thorough and complete, and will fully convey the scope of the invention to those skilled in the art. Like reference numerals refer to like elements throughout.

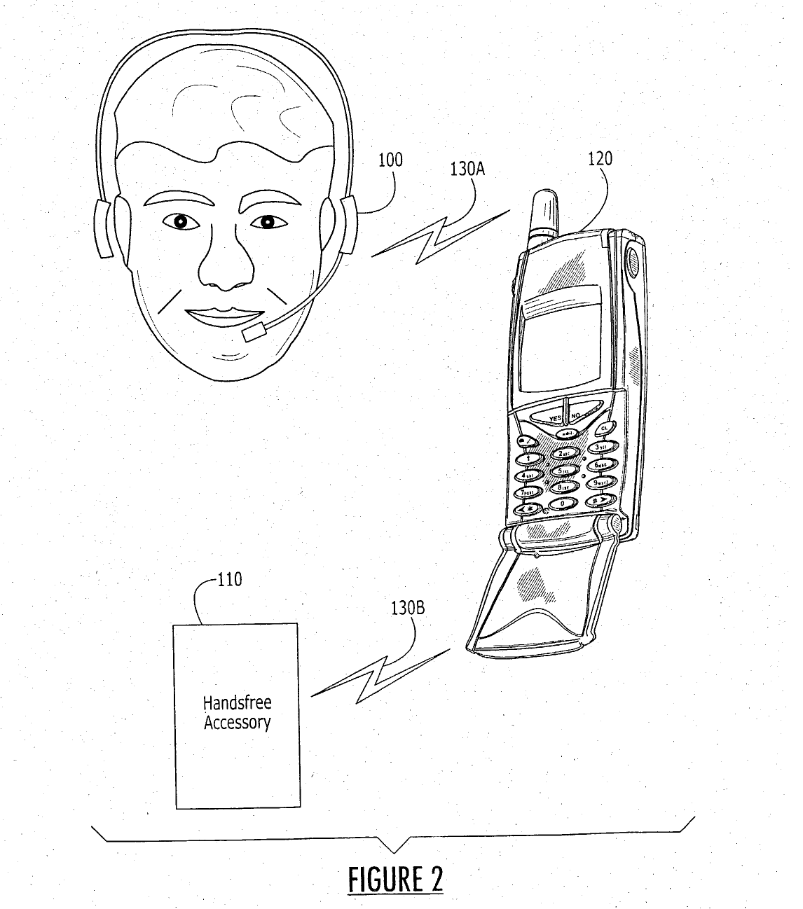

Embodiments of the present invention will now be further described with reference to FIGS. 2-4. In FIG. 2, a wireless terminal 120 is illustrated as operating in a handsfree environment that includes a headset 100, as one handsfree accessory, and another handsfree accessory 110. In a wireless communication system adapted for vehicle use, the handsfree accessory 110 may be treated as a conference accessory having speaker and microphone elements (not shown) therein. These elements may be of conventional design. In some cases, the conference accessory may be a handsfree accessory that is permanently mounted or integrated within the vehicle. As described more fully hereinbelow, the wireless terminal 120 preferably operates as a switching node that supports a first bidirectional wireless audio communication link 130A to the headset 100. This first communication link 130A may also be switched without interruption to the handsfree accessory 110 and thereby operate as a second bidirectional wireless audio communication link 130B, and vice versa. These switching operations are performed in response to respective commands, which may include voice or other commands. In preferred embodiments, only one of the communication links is active at a time. In alternative embodiments, at least one of the communication links may be a non-audio signal. The communication links 130A and 130B may also be established using Bluetooth™ wireless technology. Accordingly, the communication links may be established as a spread spectrum (e.g., 2.4 GHZ spectrum), frequency hopping, full-duplex signals that hop at 1 MHz intervals.

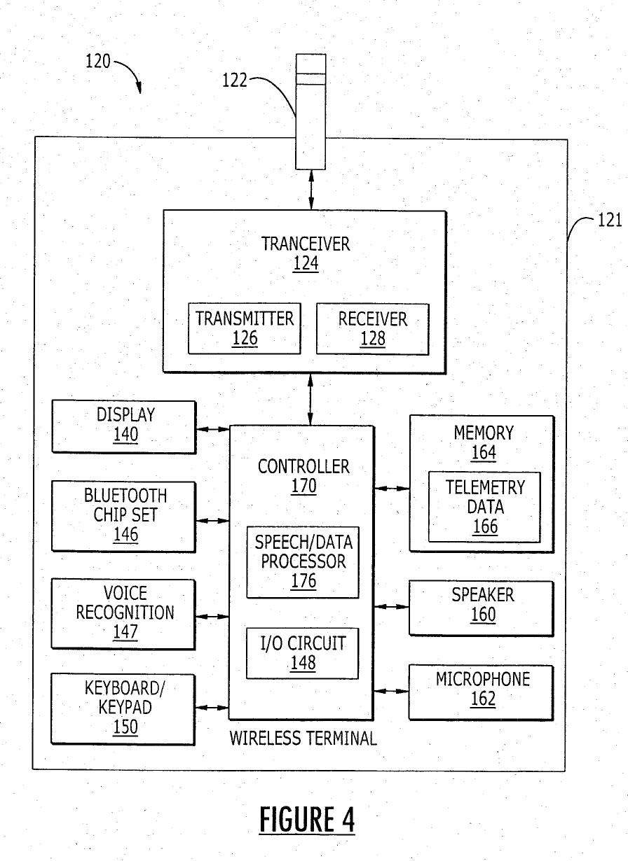

A detailed block diagram of the wireless terminal 120 of FIG. 2 is illustrated in FIG. 4. In FIG. 4, the wireless terminal 120 is illustrated as including a portable housing 121, a keyboard/keypad 150, a display 140, a speaker 160, a microphone 162, a transceiver 124, and a memory 164 that is configured to communicate with a controller 170. The transceiver 124, as illustrated, includes a transmitter circuit 126 and a receiver circuit 128, which, respectively, transmit outgoing radio frequency signals to a base station transceiver (not shown) and receive incoming radio frequency signals from the base station transceiver, via an antenna 122. The radio frequency signals transmitted between the wireless terminal 120 and the base station transceiver may comprise both traffic and control signals (e.g., paging signals/messages for incoming calls), which are used to establish and maintain communication with another remote party or destination. The transceiver 124 may further operate to provide signals to the I/O circuit 148.

Various of the foregoing components of the wireless terminal 120, other than those described further herein, may be included in many conventional wireless terminals and their functionality is generally known to those skilled in the art. It should be further understood, that, as used herein, the term “wireless terminal” may include a cellular radiotelephone with or without a multi-line display; a Personal Communications System (PCS) terminal that may combine a cellular radiotelephone with data processing, facsimile and data communications capabilities; and a Personal Data Assistant (PDA) that can include a radiotelephone, pager, Internet/intranet access, Web browser, organizer, calendar and/or a global positioning system (GPS) receiver.

The controller 170 may include a speech/data processing circuit 176 as well as other functional modules not illustrated in FIG. 4 but which will be understood to those of skill in the arts related to wireless communications including both data and voice communication support. The speech/data processing circuit 176 may include components such as demodulators, decoders, interleavers and RF processor circuitry. The controller 170, such as a microprocessor, microcontroller or similar data processing device, may execute program instructions stored in the memory 164, such as a dynamic random access memory (DRAM), electrically erasable programmable read-only memory (EEPROM) or other storage device.

The transceiver 124, the speech/data processing circuit 176 and other components of the wireless terminal 120 may be implemented using a variety of hardware and software elements. For example, operations of the transceiver 124 and/or the speech/data processing circuit 176 may be implemented using special-purpose hardware, such as an application specific integrated circuit (ASIC) and programmable logic devices such as gate arrays, and/or software or firmware running on a computing device such as a microprocessor, microcontroller or digital signal processor (DSP). Although functions of the transceiver 124 and the other circuits shown in FIG. 4 may be integrated in a single device, such as a single ASIC microprocessor, they may also be distributed among several devices. Aspects of these circuits may also be combined in one or more devices, such as an ASIC, DSP, microprocessor or microcontroller. These various implementations may use hardware, software, or a combination of hardware and software and are generally referred to herein as “circuits.” As described more fully in U.S. application Ser. No. 10/222,520, filed Aug. 16, 2002, which is hereby incorporated herein by reference, a feature use circuit (not shown), which may be disposed within the controller 170 of the wireless terminal 120, can be configured to collect telemetry data 166 for the wireless terminal 120. The telemetry data 166 stored within the memory 164 is typically collected during normal operation of the wireless terminal 120. The telemetry data 166 collected may include feature telemetry data, for example, ring tones, or performance telemetry data, for example, signal strength.

The wireless terminal 120 may also include a voice recognition device 147 that communicates with the controller 170. This voice recognition device 147, which typically includes both hardware and software components, may be configured to detect and process voice commands detected by the wireless terminal 120. The voice recognition device 147 may designed using conventional design techniques that are well known to those skilled in the art of voice recognition and signal processing.

A Bluetooth™ chip set 146 is also provided within the wireless terminal 120. This chip set 146, which communicates with and is controlled by the controller 170, supports bidirectional wireless audio communication links with the headset 100 and handsfree accessory 110, as described herein. As will be understood by those skilled in Bluetooth™ and related technologies, the headset 100 and handsfree accessory 110 are also equipped with corresponding Bluetooth™ technology components. In alternative embodiments, conventional technologies other than Bluetooth™ technology may be implemented to establish the communication links illustrated by FIG. 2.

Accordingly, as illustrated and described above with respect to FIGS. 2 and 4, wireless communication systems according to some preferred embodiments include a wireless terminal 120. This terminal 120 is configured to support private and conference calling in a handsfree environment, such as a vehicle environment. In particular, the wireless terminal 120 may be configured to support bidirectional wireless audio communication with a vehicle-based user headset 100 and a vehicle-based hands free accessory 110, such as a conference accessory. The wireless terminal 120 operates as a switching node that is configured to support uninterrupted transfer of an already established first bidirectional wireless audio communication link 130A from the headset 100 to the conference accessory. This transfer operation may be made in response to a first command, such as a voice command received by the voice recognition device 147. This first command may also be entered into the wireless terminal 120 using conventional techniques (e.g., input via keypad entry using a menu-based display or a switch contact on the housing 121). The wireless terminal 120 is further configured to support uninterrupted return of a wireless audio communication link 130B from the conference accessory to the headset 100. This return operation may be made in response to a second command, which may also be a voice command or other type of command.

Still further embodiments include a wireless terminal 120 that is configured to support wireless communication with first and second handsfree (or handheld) accessories 110. In these embodiments, the wireless terminal operates as a switching node that is configured to generate an outgoing first wireless communication link from the wireless terminal to the first accessory and simultaneously generate an alternative format version of the outgoing first wireless communication link from the wireless terminal to the second accessory. This alternative format version of the outgoing first wireless communication link may be a format that is compatible with devices that do not generate acoustic signals. For example, devices such as printers, displays, or other devices that support communication with a hearing-impaired member of a conference call may be used as a handsfree accessory. Other configurations are also possible.

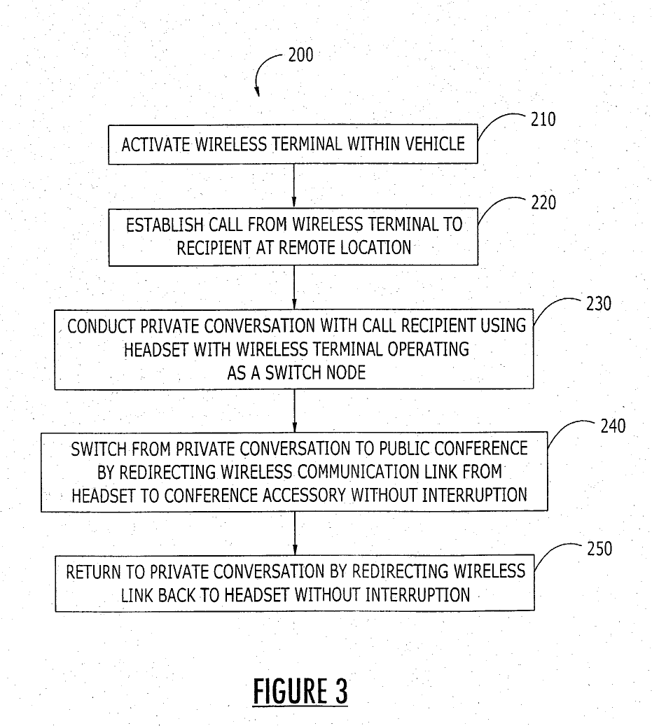

The devices of FIGS. 2 and 4 may also be utilized to conduct a vehicle-based conference call with a remote call recipient (not shown). As illustrated by FIG. 3, methods 200 according to embodiments of the present invention may include activating a wireless terminal within a vehicle, Block 210, and establishing a call from a wireless terminal to the call recipient, Block 220. These methods also include conducting a private conversation with the remote call recipient using a vehicle-based headset that communicates with a wireless terminal using a bidirectional wireless audio communication link, Block 230. An operation is then performed to switch from the private conversation to a public conference with the call recipient. This is done by redirecting the bidirectional wireless audio communication link from the headset to a vehicle-based handsfree conference accessory, using the wireless terminal as a switching node, Block 240. This redirecting operation is preferably performed in response to a command and without interruption of the ongoing call with the recipient. Next, an operation is performed to return to the private conversation by redirecting the bidirectional wireless audio communication link from the conference accessory to the headset, again without interruption, Block 250. This operation to redirect the communication link is also performed in response to a command.

Referring again to FIG. 4, the controller 170 within the wireless terminal 120 may operate in accordance with programmed call priorities between the various handsfree accessories (see, e.g., 100 and 110). In particular, the wireless terminal 120 may be configured to support bidirectional wireless audio communication with accessories having different call priorities. In this case, the controller 170 may include a communication control circuit that is configured to at least periodically monitor the active/inactive states of all the accessories and maintain communication with whatever active accessory has the highest call priority. In the illustrated example of FIG. 2, the headset 100 has a higher call priority relative to the handsfree accessory 110. This monitoring of the state of the highest priority accessory may be performed using components of the Bluetooth™ chip set 146 that can detect when the headset 100 has been turned “on” and “off”. The control circuit is further configured to automatically switch an active bidirectional wireless audio communication link 130A from the headset 100 to the handsfree accessory 110 upon detection that the headset 100 has been turned off. The control circuit is also configured to automatically switch the active bidirectional wireless audio communication link 130B from the handsfree accessory 110 to the headset 100 upon detection that the headset 100 has been turned on. In this manner, it is not necessary for the driver of the vehicle to generate a voice command that can be detected over the conversation within the vehicle or manually access the wireless terminal 120 in order to have it switch back and forth from one audio accessory to another audio accessory. The communication control circuit may be coupled to programmable storage elements (e.g., memory 164) that are configured to retain the call priorities and enable reordering of the high-to-low call priority hierarchy, if necessary.

In the drawings and specification, there have been disclosed typical preferred embodiments of the invention and, although specific terms are employed, they are used in a generic and descriptive sense only and not for purposes of limitation, the scope of the invention being set forth in the following claims.

That which is claimed is:

1. A wireless communication system for vehicle-based private and conference calling, comprising:
a wireless terminal that is configured to support bidirectional wireless audio communication with a vehicle-based user headset and a vehicle-based conference accessory, said wireless terminal operating as a switching node that is configured to support uninterrupted transfer of an already established first bidirectional wireless audio communication link from the headset to the conference accessory, in response to a first command.

2. The system of claim 1, wherein said wireless terminal is further configured to support uninterrupted return of the first wireless audio communication link from the conference accessory to the headset, in response to a second command.

3. The system of claim 2, wherein the first and second commands are voice commands.

4. The system of claim 1, wherein said wireless terminal is selected from a group consisting of a cellular telephones, PCS handsets and PDAs.

5. The system of claim 1, wherein said wireless terminal is configured so that the first command may be entered into said wireless terminal using a keypad and menu-based display.

6. The system of claim 1, wherein the first bidirectional wireless audio communication link is a spread spectrum, frequency hopping, full-duplex signal.

7. A wireless communication system for private and conference calling, comprising:
a wireless terminal that is configured to support bidirectional wireless audio communication with a handsfree accessory and a conference accessory, said wireless terminal operating as a switching node that is configured to convert a first bidirectional wireless audio communication link between said wireless terminal and the handsfree accessory into a second bidirectional wireless audio communication link between said wireless terminal and the conference accessory, in response to a first command.

8. The system of claim 7, wherein said wireless terminal is further configured to terminate the second bidirectional wireless audio communication link and reestablish the first bidirectional wireless audio communication link, in response to a second command.

9. The system of claim 8, wherein the first and second commands are voice commands.

10. The system of claim 7, wherein said wireless terminal is selected from a group consisting of a cellular telephones, PCS handsets and PDAs.

11. The system of claim 7, wherein said wireless terminal is configured so that the first command may be entered into said wireless terminal using a keypad and menu-based display.

12. The system of claim 7, wherein the first and second bidirectional wireless audio communication links are spread spectrum, frequency hopping, full-duplex signals.

13. A wireless communication system, comprising:
a wireless terminal that is configured to support wireless communication with first and second handsfree or handheld accessories, said wireless terminal operating as a switching node that is configured to generate an outgoing first wireless communication link from said wireless terminal to the first accessory while simultaneously generating an alternative format version of the outgoing first wireless communication link from said wireless terminal to the second accessory, in response to a first command.

14. The system of claim 13, wherein the outgoing first wireless communication link is a spread spectrum, frequency hopping, full-duplex signal.

15. A wireless communication system for vehicle-based private and conference calling, comprising:
a wireless terminal that is configured to support bidirectional wireless audio communication with a vehicle-based handsfree accessory and a vehicle-based conference accessory, said wireless terminal operating as a switching node that is configured to support uninterrupted transfer of an already established first bidirectional wireless audio communication link from the handsfree accessory to the conference accessory, in response to a first command.

16. The system of claim 15, wherein the first bidirectional wireless audio communication link is a spread spectrum, frequency hopping, full-duplex signal.

17. The system of claim 16, wherein the full-duplex signal hops at 1 MHz intervals.

18. A wireless communication system for private and conference calling, comprising:
a wireless terminal that is configured to support bidirectional wireless communication with a first handsfree accessory and a second handsfree accessory, said wireless terminal operating as a switching node that is configured to convert a first bidirectional wireless communication link between said wireless terminal and the first handsfree accessory into a second bidirectional wireless communication link between said wireless terminal and the second handsfree accessory, in response to a first command.

19. The system of claim 18, wherein said wireless terminal is further configured to terminate the second bidirectional wireless communication link and reestablish the first bidirectional wireless communication link, in response to a second command.

20. The system of claim 19, wherein the first and second commands are voice commands.

21. The system of claim 18, wherein said wireless terminal is selected from a group consisting of a cellular telephones, PCS handsets and PDAs.

22. The system of claim 18, wherein said wireless terminal is configured so that the first command may be entered into said wireless terminal using a keypad and menu-based display.

23. The system of claim 18, wherein the first and second bidirectional wireless communication links are spread spectrum, frequency hopping, full-duplex signals.

24. The system of claim 23, wherein at least one of the first and second bidirectional communication links are non-audio data links.

25. A method of conducting a vehicle-based conference call with a remote call recipient, comprising the steps of:
conducting a private conversation with the remote call recipient using a vehicle-based headset that communicates with a wireless terminal using a bidirectional wireless audio communication link;
switching from the private conversation to a public conference with the remote call recipient by redirecting the bidirectional wireless audio communication link from the headset to a vehicle-based handsfree conference accessory without interruption; and
returning to the private conversation by redirecting the bidirectional wireless audio communication link from the conference accessory to the headset without interruption.

26. The method of claim 25, wherein the bidirectional wireless audio communication link is a spread spectrum, frequency hopping, full-duplex signal.

27. The method of claim 25, wherein said switching and returning steps are performing in response to respective voice commands.

28. A wireless communication system for vehicle-based private and conference calling, comprising:
a wireless terminal that is configured to support bidirectional wireless audio communication with a plurality of vehicle-based audio accessories having different call priorities, said wireless terminal comprising a communication control circuit that is configured to at least periodically monitor an active/inactive state of a first one of the plurality of audio accessories having a highest call priority and is further configured to automatically switch an active bidirectional wireless audio communication link from the first one of the plurality of audio accessories to a second one of the plurality of audio accessories having a next highest call priority upon detection that the first one of the plurality of audio accessories has become inactive.

29. The system of claim 28, wherein the communication control circuit is further configured to automatically switch an active bidirectional wireless audio communication link from the second one of the plurality of audio accessories to the first one of the plurality of audio accessories upon detection that the first one of the plurality of audio accessories has become active.

30. The system of claim 29, wherein the first one of the plurality of audio accessories is a vehicle-based headset and the second one of the plurality of audio accessories is vehicle-based conference accessory.

31. The system of claim 29, wherein the first one of the plurality of audio accessories is a vehicle-based conference accessory and the second one of the plurality of audio accessories is vehicle-based headset.

32. The system of claim 29, wherein the communication control circuit comprises programmable storage elements that are configured to retain the call priorities.

33. A wireless communication system, comprising:
a wireless terminal that is configured to support wireless communication with a plurality of accessories having different priorities, said wireless terminal comprising a communication control circuit that is configured to detect an active-to-inactive transition of a first one of the plurality of accessories having a highest priority and is further configured to automatically switch an active wireless communication link from the first one of the plurality of accessories to a second one of the plurality of accessories having a next highest priority upon detection of the active-to-inactive transition.

34. The system of claim 33, wherein the communication control circuit is configured to detect an inactive-to-active transition of the first one of the plurality of accessories and is further configured to automatically switch the active wireless communication link from the second one of the plurality of accessories to the first one of the plurality of accessories upon detection of the inactive-to-active transition.
